(19) United States
(12) Patent Application Publication
(10) Pub. No.: US 2022/0159892 A1
(43) Pub. Date: May 26, 2022

(54) UTENSIL FOR AGRICULTURAL WORKING

(71) Applicant: TORRICO S.R.L., GAMBELLARA (VI) (IT)

(72) Inventor: Luciano PEGORARO, GAMBELLARA (V) (IT)

(21) Appl. No.: 17/594,291

(22) PCT Filed: Apr. 6, 2020
(86) PCT No.: PCT/IT2020/050089

§ 371 Date: Oct. 8, 2021

(30) Foreign Application Priority Data
Apr. 11, 2019 (IT) 102019000005628

(51) Int. Cl. A01B 23/02; A01B 39/22

(52) U.S. Cl. CPC A01B 23/02; A01B 39/22

(57) ABSTRACT

The invention relates to a utensil (1) for agricultural working provided with two main elements, a work tool (2) and a support element (3), made so as to be couplable to each other by means of a fastening device (4). Such device (4) is received in an opening (5) made on the support element (3) and in abutment surfaces (60, 61) which are made on the work tool (2); said abutment surfaces (60, 61) advantageously are shaped so that the tool (2) can be coupled and locked with the support element (3) according to whether the device (4) abuts with one of the ends thereof with one or with the other of the two abutment surfaces (60, 61).

The present invention falls within the scope of farming tools and utensils and equipment for working the soil. The invention in particular refers to farming utensils comprising a tool for working the soil and a support element which can be fastened to a farm vehicle, where such support element can be disconnected from the vehicle itself.

It is common practice in agriculture to use farming apparatuses generically defined as cultivators; such class of tools includes among others, ploughs, spiked harrows, subsoil ploughs, etc.

Such tools comprise a plurality of work elements fastened to a support frame of the movable farm vehicle, for example a tractor, and prepared to perform the soil working procedures such as ploughing the subsoil, ploughing, cultivating, minimum tillage, etc.

The frame of said tools can be fastened to and directly supported by the tractor or can be dragged thereby, for example by means of wheels.

The working tools can have various shapes and sizes based on the tasks to be performed, and they are fastened to support elements generally having an elongated and/or curved shape, called spring-loaded tines, which in turn are connected to the support frame.

A farming apparatus, or cultivator, comprises a support frame provided with a plurality of aligned or offset spring-loaded tines, each fastened to a work tool.

The work tools can also be disassembled to be replaced with new tools due to wear or damage, or with different tools when the farmer requires performing different operations on different soil.

For this reason, the work tools are reversibly fastened to a connecting end of the support element, for example by means of screws or bolts.

However, due to scale, rust, dirt, soil, etc., the fastening means can become locked, making the release operation longer and more difficult, especially if the cultivator comprises several spring-loaded tines, each with the respective work tool. Without considering this, the farmer in any case is to arrange adequate means for removing the fastening devices of the work tools; moreover, if bolts or the like are involved, the same can be lost too easily once they are removed.

A utensil for agricultural working having the technical features which can be considered the closest prior art to the following invention, features which are present in the preamble to appended claim 1, are described for example in patent documents US2018/288929A1, U.S. Pat. No. 8,770,311B2, U.S. Pat. No. 3,773,114A, GB2209651A.

To circumvent these drawbacks, farming work devices were conceived comprising an adaptor fastened by means of bolts to a free end of the support element and configured to be engaged by a leg or stem of the agricultural working machine.

The tool can be assembled on the adaptor and locked in working position. For this purpose and in order to ensure the farming tool is not disengaged from the adaptor during the work, specific locking means which mutually fasten the tool and the adaptor are provided.

The aforesaid devices allow simplifying and accelerating the assembly/disassembly procedures of the tools to/from the spring-loaded tines, but they too have certain drawbacks. Indeed, the locking means can remain locked due to scale, rust, dirt, soil, etc. and prevent the tool from being released from the adaptor. In the same way, the leg can remain wedged and locked to the adaptor.

The aims of the invention include:
improving the known agricultural work devices comprising a work tool and a support element which can be fastened to a frame of a farm vehicle, which can be reversibly coupled to each other;
making an agricultural work device which allows assembling or disassembling a farm working tool to/from the corresponding support element, for example a spring-loaded tine, more easily and quickly;
making an agricultural work device which in any case can be associated with a farm apparatus or cultivator and which has a sturdy structure and a simple and reliable operation.

These and other aims are achieved by an agricultural work device according to appended claim 1; further technical details and features are indicated in the dependent claims.

The invention can be better understood and implemented with reference to the accompanying drawings illustrating, by way of non-limiting example, some embodiments of the farm utensil, wherein:

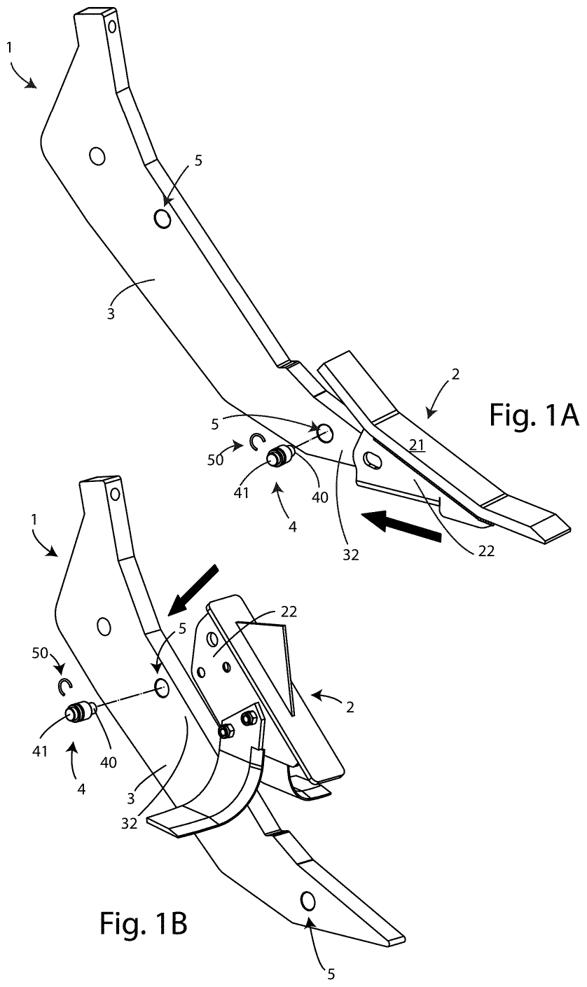

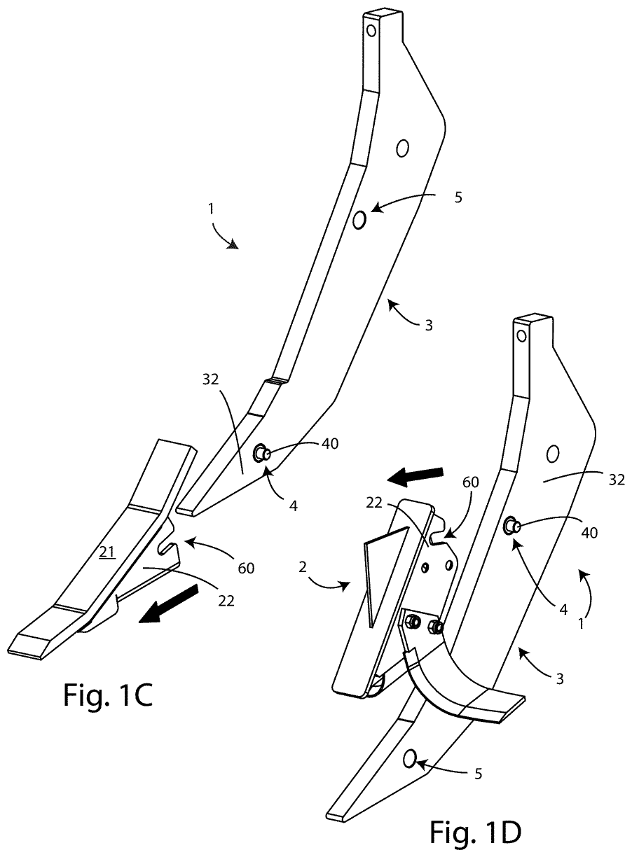

FIGS. 1A, 1B, 1C and 1D are perspective views of the agricultural work device of the invention during the assembly and disassembly step;

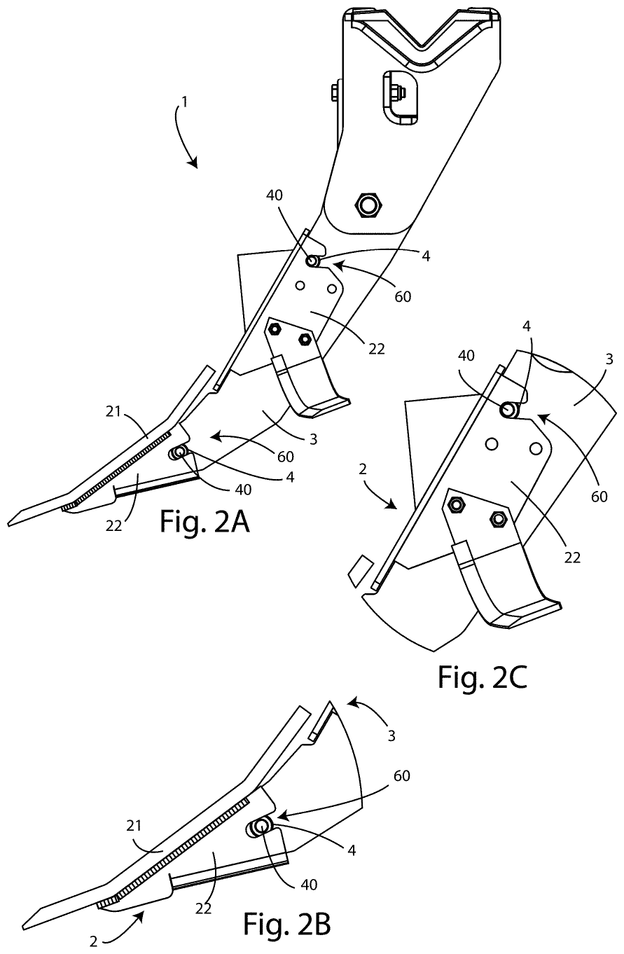

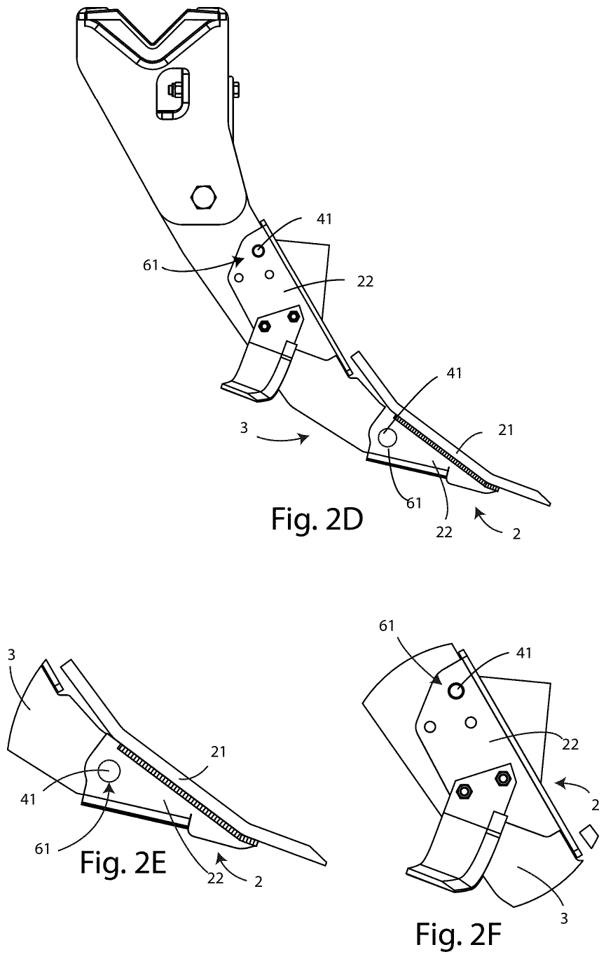

FIGS. 2A to 2F are the side views of the assembled device;

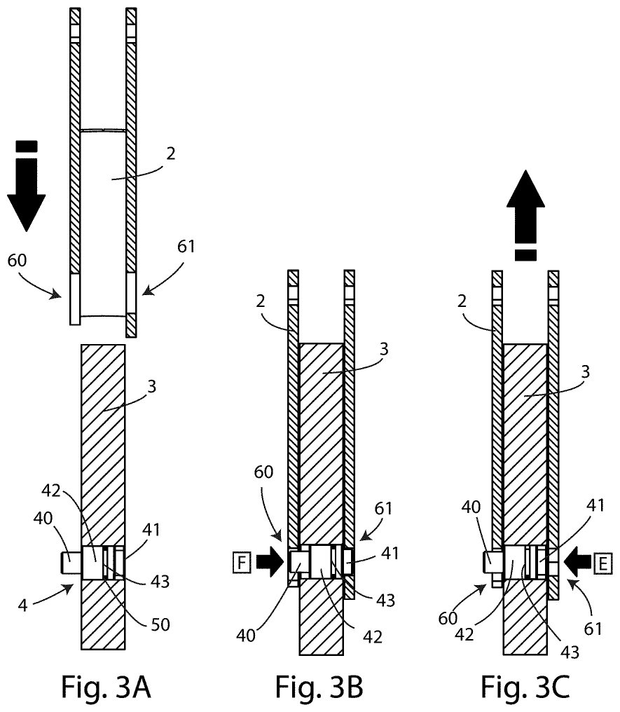

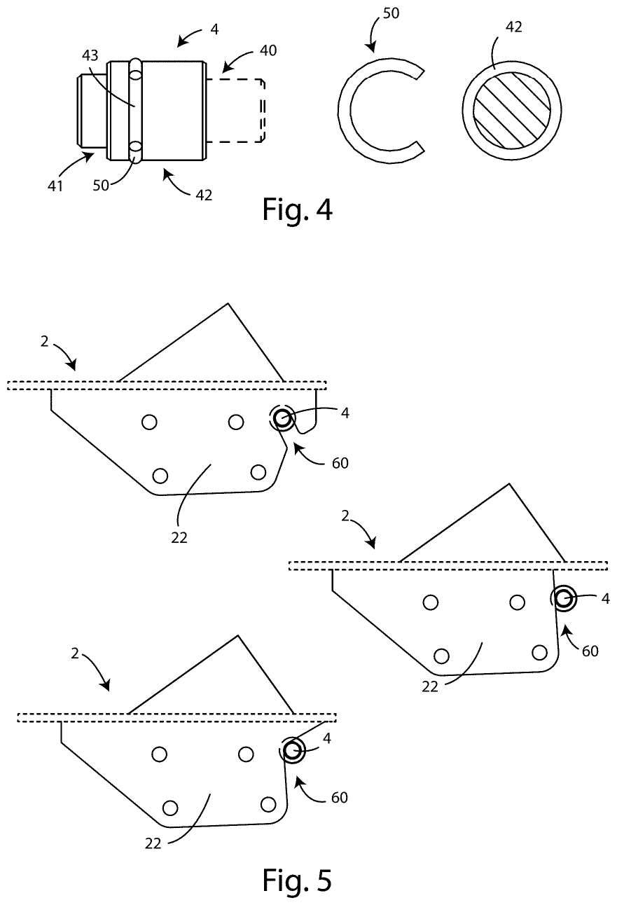

FIGS. 3 and 4 are the sections of details of FIGS. 1A to 2F;

FIG. 4 shows a detail of the fastening device according to the invention;

FIG. 5 shows different embodiments of the utensil according to the invention.

With reference to FIGS. 1A to 2F, they illustrate a utensil for farm machines 1 for working the soil which can be associated with a movable farm machine (not shown) and comprising a work tool 2 arranged to interact with the soil and a support element 3 which can be fastened to the farm machine and supported by the work tool 2.

The embodiment described and illustrated in the accompanying drawings in particular indicates a subsoiler, or scarifier, adapted to break up the more or less deep layers of the soil; however, the device the object of the present invention can advantageously be used for fastening different utensils such as, for example, a hoe, harrow, or any other farm tool adapted to work or interact with the soil.

The work tool 2 advantageously comprises a working area 21, or operating portion, which is adapted to interact with the soil, and a connecting portion 22, or shaped area, for the removable connection with the support element 3.

In the embodiment illustrated in the drawings, the support element 3 is made in a single piece and comprises holes, or openings 5, adapted to connect the work tool 2 to the support element 3, and therefore to the farm machine, by means of the insertion of a fastening device 4.

The work tool 2 and the support element 3 advantageously can be coupled to each other by means of the respective shaped areas 22 and 32, which are complementary to each other, as detailed in FIGS. 1A to 2F.

The operation of the fastening device 4 and the interaction thereof with the elements 2 and 3 can be better understood with the aid of the side views of FIGS. 2A and 2F.

They show a possible embodiment of the farm utensil 1 with the fastening device 4 in assembled configuration, and in particular with two subsoiler tools assembled.

The feature of the fastening device 4 is that, both in the assembled configuration and in the disassembled one, it always remains inserted in the opening 5 and it is capable of moving from an engaged position to a non-engaged one by means of simply sliding in the opening 5. The sliding is obtained by the farmer who acts only on the fastening device 4 by means of suitable tools, such as for example hammers or mallets.

The fastening device 4 therefore always remains accommodated in the opening 5 and is built in such a manner that one of the two ends thereof, the stem 40 or the head 41, advantageously projects from the opening 5 according to whether or not the work tool 2 is to be released or locked, respectively, from/onto the support element 3.

The work tool 2 advantageously is made with abutment surfaces 60 and 61 which can therefore allow the positioning or removal thereof, respectively, to/from the support element 3, or the locking thereon.

Said abutment surfaces 60 and 61 have differences: surface 60 advantageously can be slot-shaped or simply have a profile which serves as abutment for the device 4 to allow the insertion and the removal of the tool 2 by sliding on the support element 3, also when the stem 40 projects from the opening 5 and is in the released position; surface 61 instead is designed so as to allow the sliding of tool 2 only when the head 41 of the fastening device 4 does not project from opening 5, and therefore when the same device 4 is in the released position.

Summarizing, the surfaces 60 and 61, obtained on the opposite sides of the work tool 2, make it possible for said fastening device 4 to pass from a locked position, according to which said head 41 abuts on surface 61, to a released position, according to which said stem 40 abuts on the second surface 60, and vice versa.

FIG. 4 details the construction components of the fastening device 4. In a preferred embodiment, said device 4 can be a pin made for example, of steel, having a central body 42 with a greater diameter with respect to the ends, which consist of the stem 40 and the head 41; this is so that said pin advantageously can be coupled under a condition of clearance, albeit minimum, with the opening 5.

In a further embodiment, such stem 40—the profile of which is shown with a dashed line in FIG. 4—might also not be present: in order for the device to operate, indeed it is sufficient for the central body 42 to abut with the abutment surface 40 of the work tool 2, and the operation thereof is the one of facilitating the execution of the manual operation in the passage from the engaged and unengaged positions.

The surface of the central body 42 also has a groove 43 at a given length, adapted to house a braking element 50, which advantageously is made of steel or elastic steel or of an elastomeric material, and preferably is ring- or C-shaped, which interacts by interference with the walls of the opening 5 and ensures the solidity of the coupling.

In reference to FIGS. 3A to 3C, the work tool 2 is shown in the act of being positioned on the support element 3 (FIG. 3A) to better comprehend the operation of the fastening device 4; the fastening device 4 is in the released configuration and the head 41 thereof does not protrude from the opening 5, it being in its own seat. In this manner, the stem 40, which when present comes out of the opening 5 on the other face of the support element 3, can engage the surface 60 of the tool 2 up to the correct positioning thereof on the support element 3.

At this point, the operator can lock the work tool 2 by simply acting on the central body 42, or on the stem 40 when present, of the fastening device 4, thus moving it into the locked position (FIG. 3B) by exerting an axial force along the direction indicated by the arrow F such as to cause the sliding of the fastening device 4 along the opening 5 and the head 41 to occupy the respective seat, at the surface 61, on the work tool 2; in this manner, the head 41 abuts on the surface 61 and the work tool 2 can remain in locked position on the support element 3.

To pass from the released configuration (FIG. 3C), the farmer is only to repeat the same operation in inverse manner, applying a contrary force on the head 41 of the device 4, according to the direction of the arrow E; in this manner, the central body 42 abuts at the surface 60 and the work tool 2 can therefore slide on the support element 3 and be removed.

This excludes the possibility of accidental or unwanted release operations given that the sliding of the fastening device 4 in the opening 5 may be obtained only if an external operator exerts a direct force along the axis of said device 4 by means of a tool such as, for example hammers or mallets. FIG. 5 shows certain embodiments of the surface 60 in order to better illustrate the functionality thereof: it is worth noting that it is sufficient for such surface 60 to have at least one interfering portion, also of minimum size, capable of overlapping the opening 5, at which the central body 42 of the device 4 can abut when the tool 2 is released.

The fact that the surfaces 60 and 61 are shaped so as to prevent the complete sliding, and therefore the fastening device 4 from coming out of its own seat, advantageously excludes the possibility of accidental releases and/or losses of the pin.

Moreover, a coupling system made according to the invention allows the operator to easily and quickly assemble and disassemble the various tools from the supports, regardless of the type of tools.

The features of the invention clearly emerge from the description, as do the advantages thereof.

Finally, the invention is described by way of example only, without limiting the scope of application, according to its preferred embodiments, but it shall be understood that the invention may be modified and/or adapted by experts in the field without thereby departing from the scope of the inventive concept.

1. A utensil for agricultural working, comprising a work tool, a fastener and a support connected to said work tool,
said work tool comprising at least one shaped area designed to be positioned and reversibly connect with said support by inserting said fastener into a hole or opening,
wherein said work tool comprises, at said at least one shaped area, respective abutment surfaces made on opposite parts of said work tool which allow the insertion and accommodation of at least one portion of said fastener so that said fastener can slide in said opening, passing from a locked position to a released position and vice versa, allowing the locking or releasing, respectively, of said work tool to/from said support, characterized in that said fastener comprises:
a head and a central body, wherein said central body has a larger section with respect to the section of said head;
a stem connected to said central body, wherein said stem has a smaller section with respect to the section of said central body,
wherein said fastener remains inserted in said opening both in an assembled position, according to which said work tool is restrained to said support, and in a non-assembled position, according to which said work tool (2) is released from said support, and
wherein said head, in said locked position, abuts on a first of said abutment surfaces, and wherein said central body, in said released position, abuts on a second of said abutment surfaces.

2. The utensil for agricultural working according to claim 1, wherein said fastener is substantially a cylindrical-shaped pin.

3. The utensil for agricultural working according to claim 1, wherein said central body comprises a groove inside of which there is accommodated a brake adapted to interact by interference with said opening, thus ensuring coupling solidity between said fastener and said opening.

4. The utensil for agricultural working according to claim 5, wherein said brake is ring- or C-shaped and is made of steel, elastic steel, polymeric or elastomeric material.

5. The utensil for agricultural working according to claim 1, wherein said utensil is a subsoiler or scarifier adapted to break up the more or less deep layers of the soil.

6. The utensil for agricultural working according to claim 1, wherein a first of said abutment surfaces is slot-shaped to allow the insertion and removal of said tool simply by sliding on said support, also when said central body abuts on said first abutment surface and is in a released position.

7. The utensil for agricultural working according to claim 1, wherein at least a second of said abutment surfaces is made so as to allow the sliding of said tool only when said head of the fastener does not project from said opening, and therefore when said fastener is in released position.

8. A work tool designed to reversibly connect with a support of an agricultural utensil by means of a fastener, wherein said support is provided with an opening for slidably inserting the fastener, said fastener comprising:
a head and a central body, having a larger section with respect to the section of said head;
a stem connected to said central body, wherein said stem has a smaller section with respect to the section of said central body,
wherein said work tool comprises at least one shaped area with an abutment surface overlapping the opening by means of at least one interfering portion at which the central body of the device abuts, thus preventing the complete sliding of the fastener through the opening.
